(19) United States
(12) Patent Application Publication
(10) Pub. No.: US 2016/0325716 A1
(43) Pub. Date: Nov. 10, 2016

(54) Car Wash System

(71) Applicant: Eric Hill, Hialeah, FL (US)

(72) Inventor: Eric Hill, Hialeah, FL (US)

(21) Appl. No.: 14/705,700

(22) Filed: May 6, 2015

(51) Int. Cl. B60S 3/04; A46B 13/06; B60S 3/06; A46B 11/06

(52) U.S. Cl. CPC B60S 3/044; A46B 11/066; A46B 13/06; B60S 3/063

(57) ABSTRACT

The present invention provides a brush head assembly constructed and arranged with a water inlet, two distinct water flow channels, a user selectable valve for directing inlet water through a desired one of said two distinct water flow channels, a detergent container operatively connected with a single one of said two distinct water flow channels, a liquid interrupt valve, and a water outlet; a wand constructed and arranged with a water inlet, a hollow interior water channel, a water outlet, and a connection means formed on each of said water inlet and water outlet; and a brush head assembly including a rotational spinner head constructed and arranged with a plurality of spinner vanes, and a ball swivel assembly constructed and arranged to allow for a swivel angular offset of said rotational spinner head.

### BACKGROUND OF THE INVENTION

There are many devices on the market utilizing brushes and detergents for cleaning surfaces such as motor vehicles and the like.

However, many of these devices contain significant limitations relating to the ability of a user to effectively control each of detergent delivery and brushed position.

The present invention solves these prior deficiencies.

### SUMMARY OF THE INVENTION

In one embodiment, the present invention is a system for cleaning comprising:
a brush head assembly constructed and arranged with a water inlet, two distinct water flow channels, a user selectable valve for directing inlet water through a desired one of said two distinct water flow channels, a detergent container operatively connected with a single one of said two distinct water flow channels, a liquid interrupt valve, and a water outlet;
a wand constructed and arranged with a water inlet, a hollow interior water channel, a water outlet, and a connection means formed on each of said water inlet and water outlet; and
a brush head assembly including a rotational spinner head constructed and arranged with a plurality of spinner vanes, and a ball swivel assembly constructed and arranged to allow for a swivel angular offset of said rotational spinner head.

In one embodiment, a venturi hose constructed and arranged to transport detergent contained in said detergent container from said detergent container into said single one of said two distinct water flow channels.

In one embodiment, a user selectable valve for directing inlet water is constructed and arranged to direct inlet water through one of said two distinct water flow channels being a channel that provides water to flow through a channel formed next to said venturi tube and provide for a mixture of water and detergent via a venturi effect.

### BRIEF DESCRIPTION OF THE SEVERAL VIEWS OF THE DRAWINGS

FIG. 1 is a side view demonstrating various connected components of one embodiment according to the present invention.

FIG. 2 is a plan view demonstrating the inlet and actuator assembly according to one embodiment of the present invention.

FIG. 3 is a rear view of the inlet actuator assembly from FIG. 2.

FIG. 4 is a cross-sectional view along sectional lines A-A from FIG. 3.

FIG. 5 is a cross-sectional view along sectional lines A-A from FIG. 3 demonstrating movement of inlet water dependent on a flow valve.

FIG. 6 is a cross-sectional view along sectional lines A-A from FIG. 3 demonstrating movement of inlet water dependent on a flow valve.

FIG. 7 is a top view of the brush head assembly of one embodiment according to the present invention.

FIG. 8 is a side view of the brush head assembly of one embodiment according to the present invention.

FIG. 9 is a partial cross section view of the bottom of the brush head assembly according to one embodiment present invention.

FIG. 10 is a side view of the brush head assembly according to one embodiment of the present invention demonstrative of angular offsets of the brush head.

FIG. 11 is a cross-section view along section lines B-B from FIG. 7.

FIG. 12 is demonstrative of the various positions for input and output of water according to one embodiment of the present invention.

FIG. 13 is a side view of the wand assembly according to one of my present invention.

### DETAILED DESCRIPTION OF THE PREFERRED EMBODIMENT

The present invention provides an improved brush cleaning assembly. Assembly can includes want assembly 12 control head assembly 40 and brush head assembly 50. Inlet hose 86 is attached to control head assembly 40 at control head assembly inlet 20. Control head assembly inlet 20 if any acceptable configuration constructed and arranged to receive and secure an inlet hose. In one embodiment, control head inlet 20 is a quick connect/disconnect apparatus as is known in the art. Control had assembly 40 includes a cavity 24 constructed and arranged for a user's hand to pass there through in order to hold control head assembly 40 during operation. Control had assembly 40 further includes a detergent reservoir 16 in which detergent 18 is placed therein. The directional valve 14 is constructed and arranged to direct inlet water within control head assembly 40. Flow control valve 22 further is constructed and arranged as a needle type flow control valve providing for water to exit control head assembly 40 through control head assembly outlet 34 formed in quick connect/disconnect 20. In one embodiment venturi opening 32 is formed on flexible venturi tube 30 that extends downward into detergent 18 contained in detergent container 16. In one embodiment, as demonstrated in FIG. 5 valve 14 directs inlet water from input water channel 26 into channel 28. The movement of water through channel 28 provides a venturi effect on detergent 18 that is drawn upward from detergent container 16 and into channel 28 mixing with inlet water. As demonstrated in FIG. 6, the water detergent mixture continues flow through control head assembly 40 and exits through outlet 34.

Brush head assembly 50 includes a connect/disconnect 20 formed there on that receives wine and 80. Connection is typically achieved with wind 80 having formed on each and female connect/disconnect 82 constructed and arranged to interact with each of male connect disconnect 20 as demonstrated in the figures.

Although particular male and female components or demonstrated in the figures, the present invention contemplates any combination whereby secure connection is achieved.

Brush head assembly 50 further includes a brush head body 52 spinner head 54 spinner vane 56 and bearing 58. Water entering brush head assembly 50 is directed through flexible flow diversion tube 78 that directs inlet water to spinner vane 56 and provides for rotational movement of spinner head 54.

Brush head assembly 50 further includes a bearing retaining ring 60 associated with a swivel center post 62 and all swivel 64. Swivel retaining plate 66, plate retaining bolt 68 and center post retaining bolt 70 are constructed and arranged to allow for swivel and angular offset of cleaning head 74. Cleaning head 74 further includes a plurality of water outlet holes 72 and cloth restraining strap 76.

Wand 80 further has incorporated thereon at least one handle 84.

In use, a user will take wand 80 and a fix control head assembly 40 to a proximal end, being the end closest to the user, and a brush head assembly 52 to the distal end, being the end furthest from the user. As demonstrated in the figures the distal end of wand 80 has a slightly greater angle of curvature than proximal end.

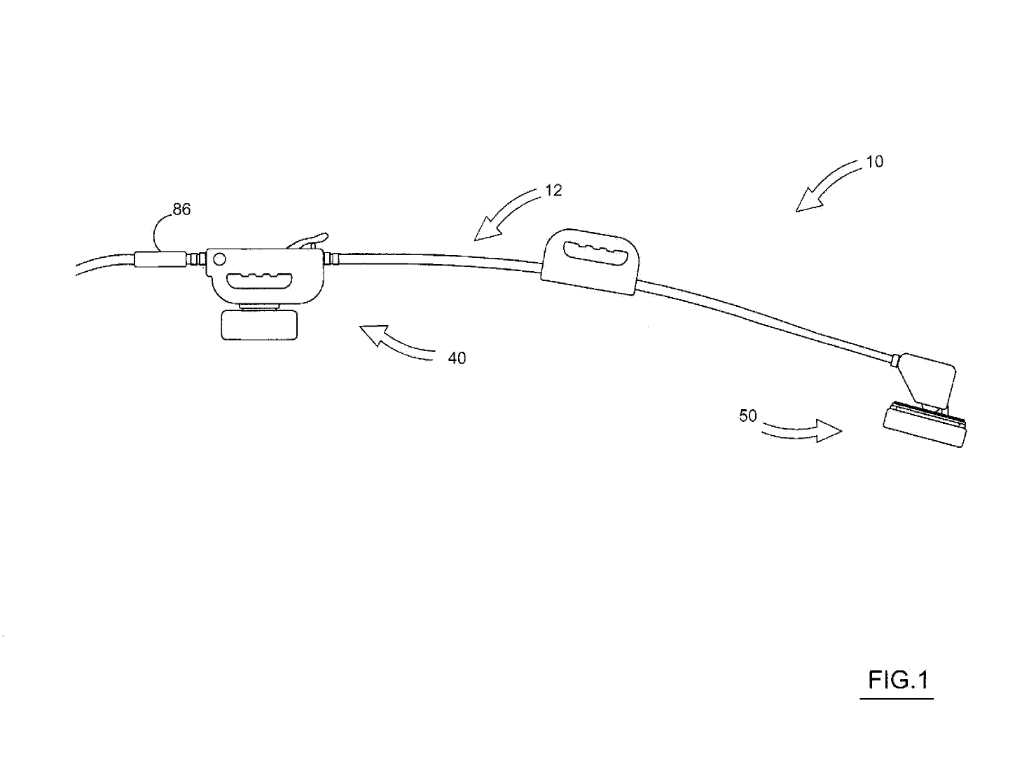

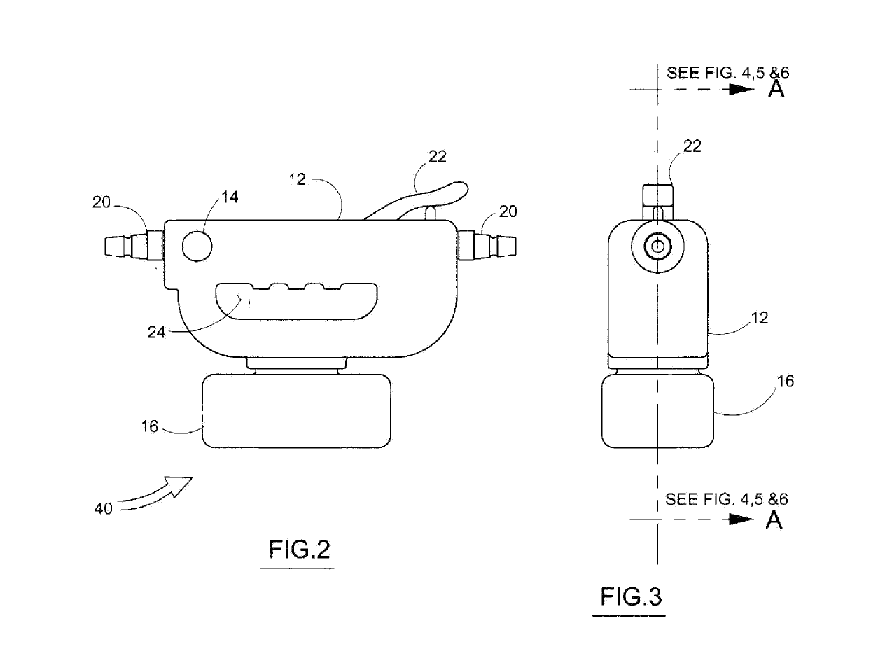

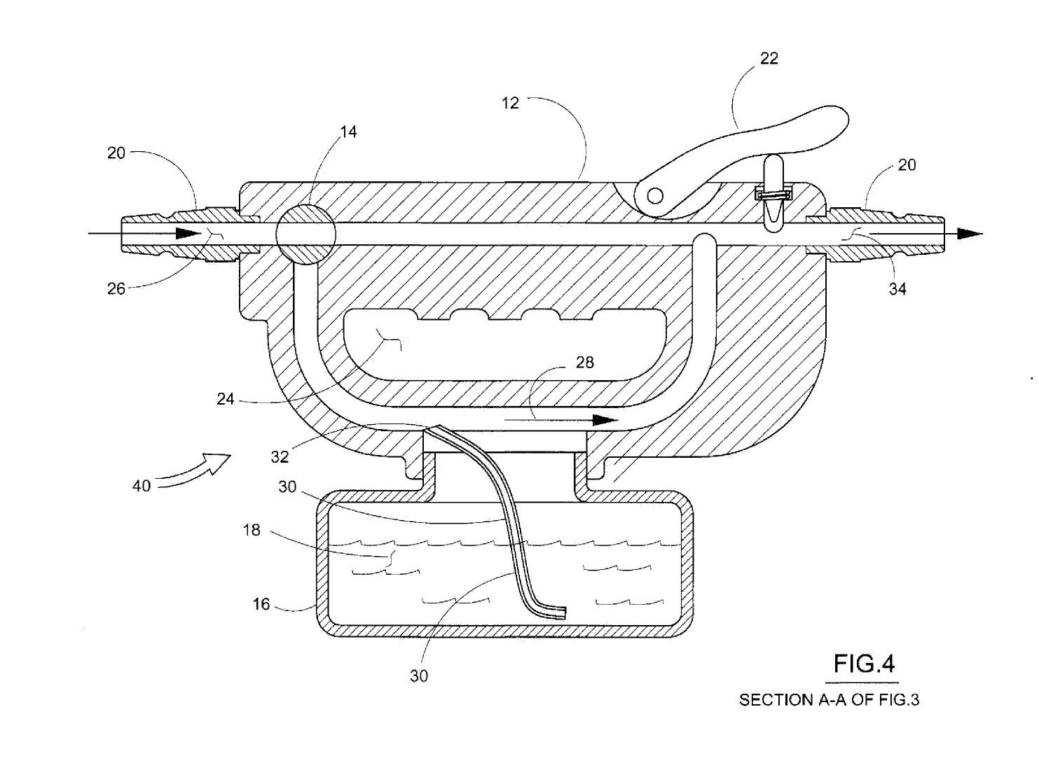

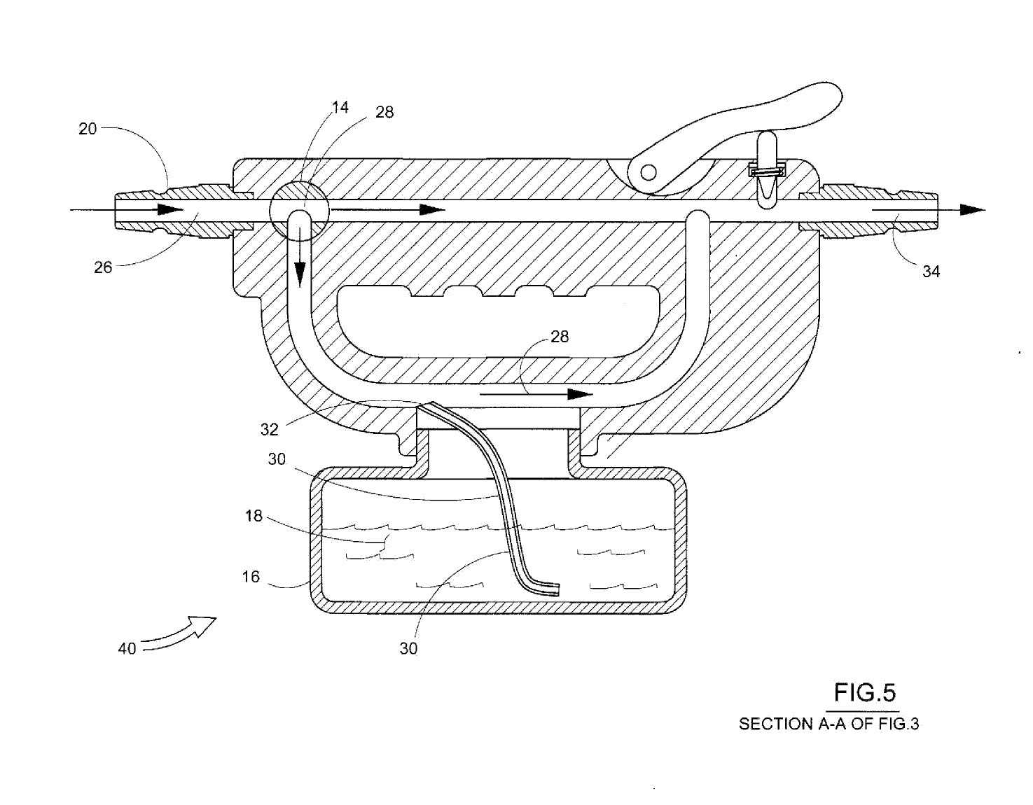

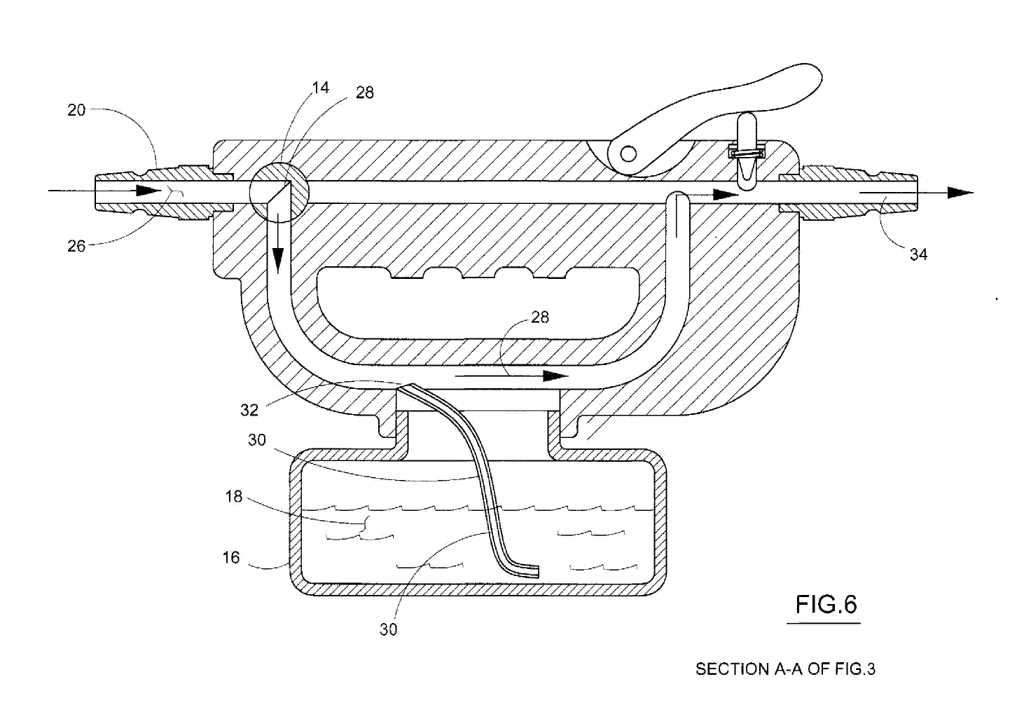

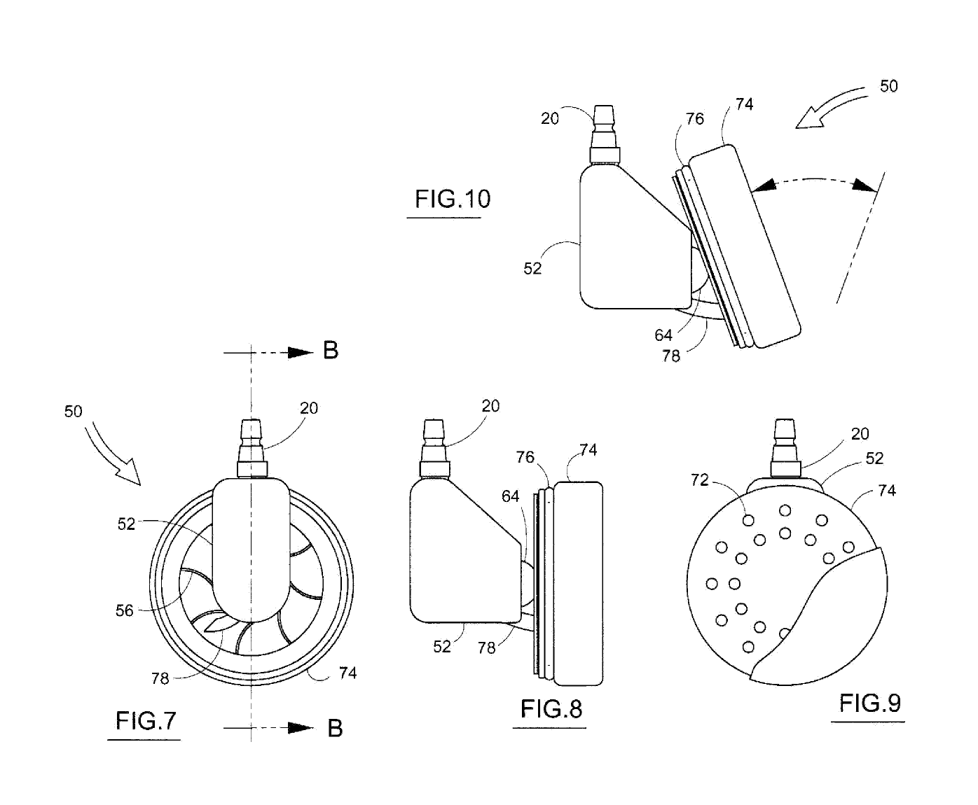

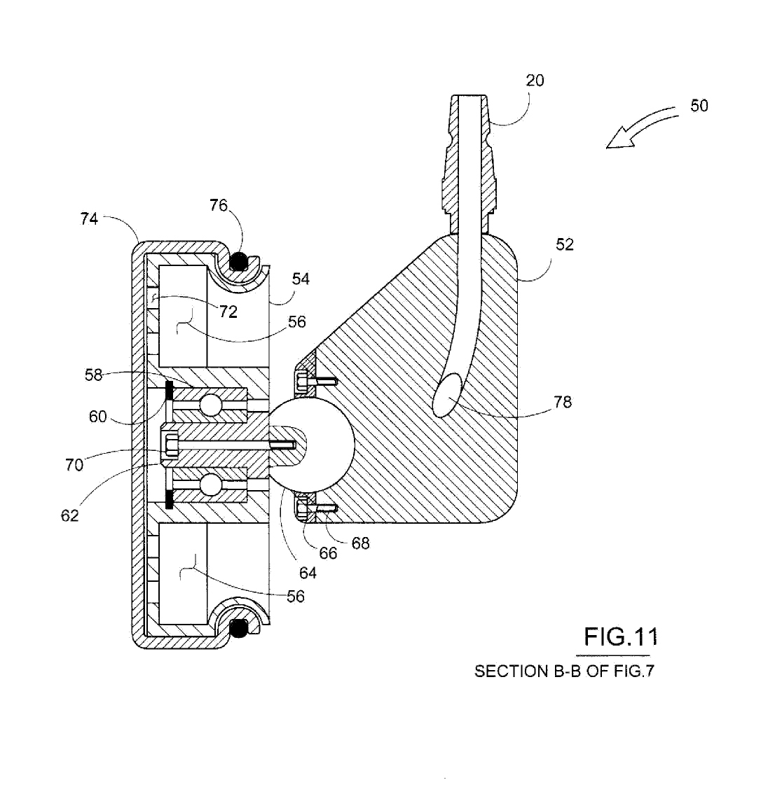

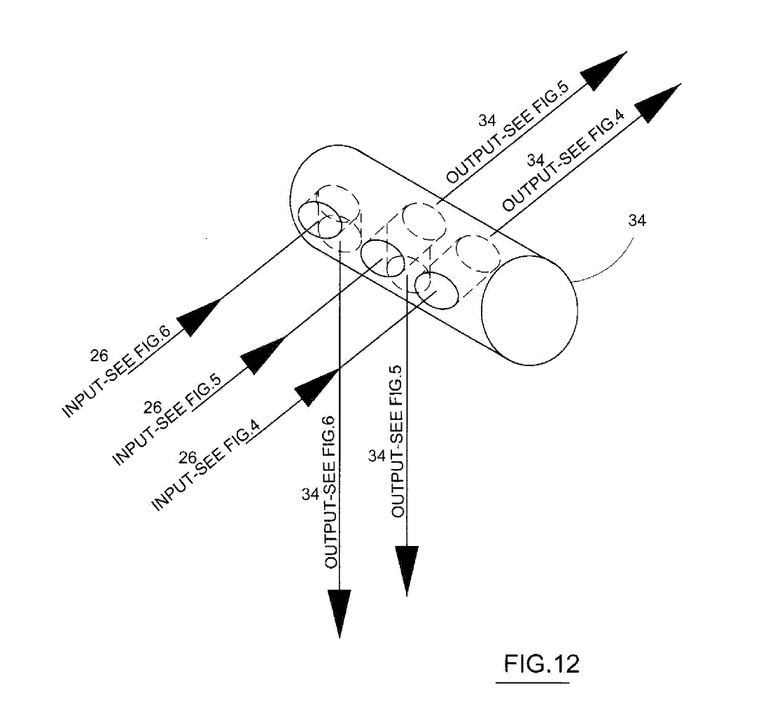

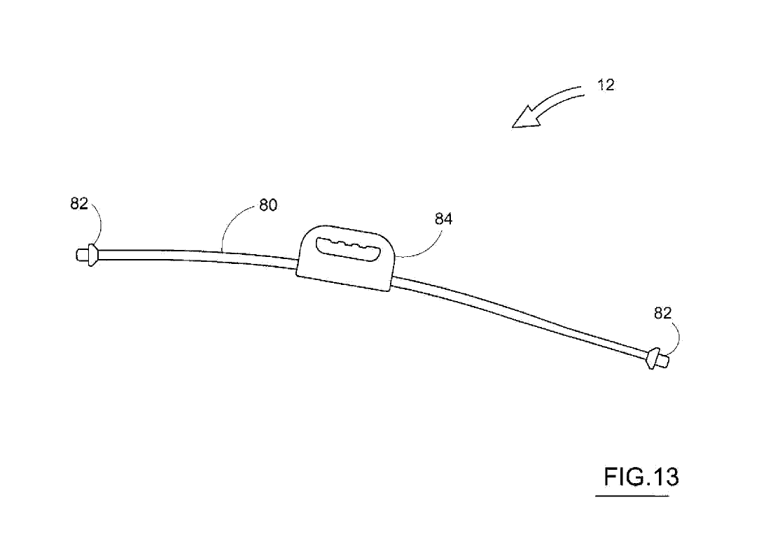

The user will then fill detergent 18 into the detergent container 16. A user will connect inlet water supply hose 86 to control head assembly 40 as shown in FIG. 1. If the user does not actuate control valve 14 water will flow across the uppermost horizontal channel of control head assembly 40 and water will not flow through channel 28 and mix with the church and 18. When directional valve 14 is actuated as demonstrated in FIG. 6 directional arrows indicate water directly downward through channel 28 whereby detergent 18 flows upward through flexible venturi tube 30 and exits venturi tube exit 32. Detergent 18, upon exiting venturi tube exit, mixes with water within channel 28th and proceeds to exit control head assembly 40 as demonstrated in FIG. 6. When a user desires to interrupt all liquid flow through assembly 10, needle flow control valve 22 is pressed downward towards the body of control head assembly 40 and the incorporated spring-loaded needle control valve interrupts all liquid flow. When a user releases needle flow control valve 22, liquid continues to flow and exits control head assembly 40 at exit 34.

As water travels through the interior cavity of the wand 80, it reaches brush head assembly 50. Water hits spinner vein 56 and causes rotational movement of spinner head 54. Water and or water mixed with detergent exits brush head assembly 50 through the plurality of water outlets 72 formed within cleaning head 74.

The present invention provides a unique configuration in which cleaning head 74 is constructed and arranged to provide a rotational angular offset as demonstrated in FIG. 10. This angular offset, or swivel, allows a user greater flexibility in washing the surface and maintaining the contact of cleaning had 74 on a desired surface. Cleaner head 74 is used either in a non-offset position as demonstrated in FIG. 8 or a desired degree of offset as demonstrated in FIG. 10. In one embodiment, the degree of offset is between about 0.1-50 degrees.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed:

1. A system for cleaning comprising:
a brush head assembly constructed and arranged with a water inlet, two distinct water flow channels, a user selectable valve for directing inlet water through a desired one of said two distinct water flow channels, a detergent container operatively connected with a single one of said two distinct water flow channels, a liquid interrupt valve, and a water outlet;
a wand constructed and arranged with a water inlet, a hollow interior water channel, a water outlet, and a connection means formed on each of said water inlet and water outlet; and
a brush head assembly including a rotational spinner head constructed and arranged with a plurality of spinner vanes, and a ball swivel assembly constructed and arranged to allow for a swivel angular offset of said rotational spinner head.

2. The system of claim 1, including a venturi hose constructed and arranged to transport detergent contained in said detergent container from said detergent container into said single one of said two distinct water flow channels.

3. The system of claim 1, user selectable valve for directing inlet water is constructed and arranged to direct inlet water through one of said two distinct water flow channels being a channel that provides water to flow through a channel formed next to said venturi tube and provide for a mixture of water and detergent via a venturi effect.
